(19) United States
(12) Patent Application Publication
(10) Pub. No.: US 2024/0296428 A1
(43) Pub. Date: Sep. 5, 2024

(54) REPAIR SITE TRANSMISSION DEVICE AND REPAIR SITE TRANSMISSION METHOD

(71) Applicants: Nissan Motor Co., Ltd., Kanagawa (JP); RENAULT S.A.S., Boulogne-Billancourt (FR)

(72) Inventors: Yuki Horihata, Kanagawa (JP); Toru Takagi, Kanagawa (JP)

(73) Assignees: Nissan Motor Co., Ltd., Kanagawa (JP); RENAULT S.A.S., Boulogne-Billancourt (FR)

(21) Appl. No.: 18/571,681

(22) PCT Filed: Jun. 25, 2021
(86) PCT No.: PCT/IB2021/000422

§ 371 Date: Dec. 18, 2023

(51) Int. Cl. G06Q 10/20; G01C 21/36; G06Q 10/02; G06Q 10/087

(52) U.S. Cl. CPC G06Q 10/20; G01C 21/3676; G06Q 10/02; G06Q 10/087

(57) ABSTRACT

A repair site transmission device is configured to: store a registered site registered based on information acquired from a vehicle or a user of the vehicle; receive an input of data indicating an abnormal level associated with a predetermined abnormality of the vehicle; acquire repair site data of a repair site where a part of the vehicle in which the predetermined abnormality is detected is to be repaired or to be replaced; and transmit the acquired repair site data to an external device. An inventory status of a replacement part for the target part or a reservation status of the repair site is acquired. The repair site data is acquired according to the abnormal level and the inventory status or the reservation status.

### TECHNICAL FIELD

The present invention relates to a repair site transmission device and a repair site transmission method.

### BACKGROUND ART

A technique is known in which by comparing a vehicle management table that stores data on parts and maintenance history of a vehicle owned by a user with a general-purpose table indicating deterioration levels corresponding to the progress of maintenance, it is determined whether or not there is a part required to be inspected or a part required to be maintained, and if any, the user of the vehicle is notified that there is a part required to be inspected or a part required to be maintained (Patent Document 1).

According to the technique disclosed in Patent Document 1, the user is asked whether or not to request to have the vehicle inspected or the like immediately, and in response to a user input indicating a request for an immediate vehicle inspection and the like, the user is notified of the nearest maintenance location as a result of search performed based on the current location of the vehicle, while in response to a user input indicating no request for an immediate vehicle inspection and the like, the user is notified of the nearest maintenance location as a result of search performed based on the user's address.

### PRIOR ART DOCUMENT

### Patent Document

Patent Document 1: International Publication No. 2003/083742

### SUMMARY OF INVENTION

### Problems to be Solved by Invention

However, in the technique of Patent Document 1, the user will be notified of the nearest maintenance location based on the current location of the vehicle even at abnormal levels that do not require immediate maintenance because the user is required to select whether or not to request an immediate vehicle inspection and the like without knowing the magnitude of the abnormal level of the vehicle. Therefore, there is a problem in that the information on a repair site provided to the user is not information suitable for the abnormal level of the vehicle.

A problem to be solved by the present invention is to provide a repair site transmission device and a repair site transmission method that can provide a user with information on a repair site according to the abnormal level of a vehicle.

### Means for Solving Problems

The present invention solves the above problem by storing a registered site registered based on information acquired from a vehicle or a user of the vehicle; receiving an input of data indicating an abnormal level associated with a predetermined abnormality of the vehicle; determining, based on the abnormal level, whether or not to acquire repair site data of a repair site where a part of the vehicle in which the predetermined abnormality is detected is to be repaired or to be replaced, starting from the registered site; acquiring the repair site data of the determined repair site; and transmitting the acquired repair site data to an external device.

### Effects of Invention

According to the present invention, it is possible to provide a user with information on a repair site according to the abnormal level of a vehicle.

### BRIEF DESCRIPTION OF DRAWINGS

FIG. 1 is a configuration diagram illustrating an example of a repair site transmission device according to the present embodiment.

FIG. 2 is a flowchart illustrating an example of a procedure of a repair site transmission method according to Example 1.

FIG. 3A illustrates a specific example of presenting repair sites according to Example 1.

FIG. 3B illustrates a specific example of presenting repair sites according to Example 1.

FIG. 4 is a diagram illustrating an example of a repair site transmission device according to Example 2.

FIG. 5 is a flowchart illustrating a repair site transmission method according to Example 2.

FIG. 6 illustrates a specific example of presenting broken parts according to Example 2.

FIG. 7 is a diagram illustrating an example of a repair site transmission device according to Example 3.

FIG. 8 is a flowchart illustrating a repair site transmission method according to Example 3.

FIG. 9A illustrates a specific example of presenting repair sites according to Example 3.

FIG. 9B illustrates a specific example of presenting repair sites according to Example 3.

FIG. 10 is a diagram illustrating an example of a repair site transmission device according to Example 4.

FIG. 11 is a flowchart illustrating a repair site transmission method according to Example 4.

FIG. 12 illustrates a specific example of presenting emergency stop sites according to Example 4.

### MODE(S) FOR CARRYING OUT THE INVENTION

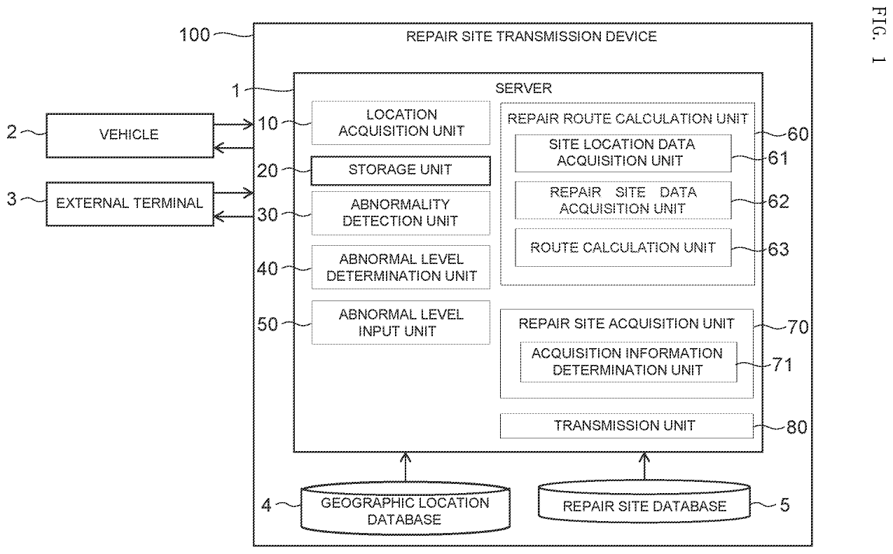

An embodiment of a repair site transmission device according to the present invention will be described below with reference to the drawings. FIG. 1 is a configuration diagram illustrating an example of a repair site transmission device 100 according to the present embodiment. As illustrated in FIG. 1, the repair site transmission device 100 is connected to a vehicle 2 via a network that constitutes a telecommunications network. The repair site transmission device 100 may be connected to a plurality of vehicles. The repair site transmission device 100 is also connected to an external terminal 3 via a network. The repair site transmission device 100 may be connected to a plurality of external terminals 3. The repair site transmission device 100 acquires vehicle data from the vehicle 2 and acquires geographic location data from the vehicle 2 and/or the external terminal 3 via the network. The repair site transmission device 100 includes a server 1, a geographic location database 4, and a repair site database 5.

The server 1 includes a computer having hardware and software, and this computer includes a ROM that stores a program, a CPU that executes the program stored in the ROM, and a RAM that functions as an accessible storage device. Note that the operable circuits to be used include, instead of or together with the CPU, an MPU, a DSP, an ASIC, an FPGA, and the like. The geographic location database 4 is a map database including geographic location data.

The geographic location data is, for example, information such as latitude, longitude, and altitude, with text information such as place names and names added. The geographic location database 4 includes geographic location data of POIs.

The repair site database 5 is a database that stores repair site data regarding repair sites. The repair site is a place where a part of a vehicle in which an abnormality is detected is to be repaired or to be replaced, and includes, for example, a dealer's shop and a repair shop. The repair site data includes, for each repair site, location data of the repair site and data on a repair service provider. The repair site data also includes data on a repair site where a shop is located, for example, the latitude and longitude of the location where the repair shop is located, and the name of the repair shop, as well as the latitude and longitude of the location of a repair service provider that does not have a shop but provide repair services, and information on the repair service provider. The server 1 acquires geographic location data from the geographic location database 4 and acquires repair site data from the repair site database 5. In the present embodiment, the geographic location database 4 and the repair site database 5 are databases stored in the repair site transmission device 100, but are not limited to this, and may be databases outside of the repair site transmission device 100.

The server 1 includes, as functional blocks, a location acquisition unit 10, a storage unit 20, an abnormality detection unit 30, an abnormal level determination unit 40, an abnormal level input unit 50, a repair route calculation unit 60, a repair site acquisition unit 70, and a transmission unit 80, and executes these functions in cooperation with software and hardware for implementing each function or executing each process. Note that, in the present embodiment, the functions of the server 1 are divided into eight blocks, and the function of each functional block will be described. However, the functions of the server 1 do not necessarily have to be divided into eight blocks, and may be divided into seven or less functional blocks or nine or more functional blocks.

The server 1 acquires the current location of the vehicle 2. The server 1 stores a registered site and repair sites. The registered site is registered based on information acquired from the vehicle 2 or the user of the vehicle 2. The server 1 also detects a predetermined abnormality in the vehicle 2, and when the predetermined abnormality is detected, determines the abnormal level associated with the predetermined abnormality. Then, the server receives an input of data indicating the determined abnormal level.

The server 1 determines repair site data of a repair site to be acquired according to the abnormal level, and transmits the acquired repair site data to the vehicle 2 and/or the external terminal 3. The repair site to be acquired is a repair site to be presented to the user. In the present embodiment, the server 1 determines, based on the abnormal level, whether or not to acquire repair site data of a repair site starting from the registered site. If it is determined to acquire the repair site data of the repair site starting from the registered site, the server 1 acquires the repair site data of the repair site starting from the registered site. If it is not determined to acquire the repair site data of a repair site starting from the registered site, that is, if it is determined to acquire the repair site data of a repair site starting from the current location, the server 1 acquires the repair site data of a repair site starting from the current location.

The repair site starting from the registered site or current location is a repair site located within a predetermined range from the registered site or the current location, for example, a repair site located within a predetermined travel distance or travel time. Further, the repair site starting from the registered site or the current location may be a repair site located within a predetermined order in ascending order of distance from the registered site or the current location. Note that the external terminal 3 is a terminal device used by the user of the vehicle 2, and may be any device such as a smartphone or a PC, for example. The external terminal 3 displays the received repair site data to the user. The user of the vehicle 2 includes a person who uses the vehicle 2, a person who owns the vehicle 2, and a person who manages the vehicle 2. The user may be an individual or a corporation. Further, the server 1 may transmit the repair site data to a plurality of external terminals 3. Further, the vehicle 2 includes a navigation device. The vehicle 2 displays the received repair site data to the user via the navigation device.

The abnormality in the vehicle as used herein is a state in which the vehicle breaks down or a state that the vehicle is likely to break down. The abnormality in the vehicle includes a factor that affects the running of the vehicle and a factor that does not affect the running of the vehicle. For example, the abnormality in the vehicle includes an abnormality in the vehicle's engine that affect running, and a malfunction of power window that does not affect running. The abnormality in the vehicle is defined, for example, by a fault code such as a DTC code indicating an abnormality in a part of the vehicle. Further, the abnormality in the vehicle includes a state in which a target part of the vehicle 2 required to be regularly replaced has not been replaced.

The abnormal level as used herein is an index representing the severity of an abnormality in the vehicle 2, and is, for example, binarized into whether the abnormal level is high or low according to the degree of influence on the running of the vehicle. Specifically, the abnormal level is set as the severity of the abnormality according to the abnormal type of the abnormality. The abnormal type represents a defective part that is expected to break down and the details regarding the related phenomenon. The abnormal type is, for example, a type identified by a fault code. Further, the abnormal level may be set based on quantitative travel conditions such as a distance by, a time for, or a range in which the vehicle 2 can travel with the abnormality in the vehicle 2 not repaired. For example, if it is determined that a distance by which the vehicle 2 in which an abnormality is detected can travel is equal to or greater than a predetermined distance, the abnormal level is determined to be “low”, and if it is determined that the distance is less than the predetermined distance, the abnormal level is determined to be “high”. Further, the abnormal level is not limited to a binary value, but may be classified into three or more types using two or more threshold values.

Further, the server 1 calculates, as a repair route, a travel route starting from the current location and/or the registered site to each repair site. The server 1 selects, from among the calculated repair routes, the repair route to the repair site determined to be acquired, and transmits repair site data including that repair route to the vehicle 2 and/or the external terminal 3. Further, the server 1 may transmit repair site data including location data of the repair site instead of repair site data including the repair route. With the above configuration, the repair site transmission device 100 determines the abnormal level and switches the repair routes to be presented according to the determined abnormal level, thereby making possible to present, to the vehicle 2 and/or the external terminal 3, a repair route according to the abnormal level.

The location acquisition unit 10 acquires current location data of the vehicle 2. The current location of the vehicle 2 is expressed, for example, by latitude and longitude. The location acquisition unit 10 acquires current location data of the vehicle 2 transmitted from a GPS or the like installed in the vehicle 2. Further, the location acquisition unit 10 may use current location data acquired by any device as long as it is a device that can acquire the current location of the vehicle 2, such as a car navigation system of the vehicle 2 or a smartphone of a user on board the vehicle 2, for example, the driver of the vehicle 2.

The storage unit 20 acquires data from the vehicle 2 and/or the external terminal 3, and stores a registered site registered based on the acquired data. The storage unit 20 acquires the geographic location data recorded in the vehicle 2 and the external terminal 3, and stores, as the registered site, the site indicated by the acquired geographic location data. The registered site includes a site input by the user, such as the location of the user's home, the location of the user's workplace, the location of a business site where the vehicle is managed, or the location of a parking lot. The registered site is stored using geographic location data registered in the external terminal 3, such as data registered in a map/local search service application installed on the external terminal 3 of the user.

For example, if the location of the user's home is registered in an application of the external terminal 3 of the user, the storage unit 20 acquires the geographic location data of the location of the user's home and stores the location of the user's home as the registered site. Further, the registered site may include a departure site, a destination, and a waypoint(s) of the vehicle 2, input by the user. For example, if the departure site, destination, and waypoint(s) of the vehicle 2 are set in the car navigation, which is an in-vehicle device of the vehicle 2, the storage unit 20 acquires geographic location data of the departure site, destination, and waypoint(s) of the vehicle 2 and stores, as the registered sites, the departure site, destination, and waypoint(s) of the vehicle 2.

Further, the registered site may be stored using the location of a POI where the vehicle 2 frequently travels or frequently drops by. For example, the storage unit 20 acquires travel history data recorded in the vehicle 2 from the vehicle 2, and calculates a POI with a high frequency of travel or drop-by. Then, the storage unit 20 uses geographic location data of POIs based on the travel history of the vehicle 2 to store, as the registered site, the location of the POI with a high frequency of travel or drop-by. Furthermore, the storage unit 20 may acquire schedule information input to the external terminal 3, estimate the action plan of the user or the vehicle 2, and store the destination of the user or the vehicle 2 as the registered site. The registered site is a site different from the current location.

The schedule information is, for example, information input into a schedule management application installed on the external terminal 3. Note that the registered site can be set as a single location or as a plurality of locations, and any information source can be used to register the registered site. Further, the method of storing the registered site is mainly set by the storage unit 20 automatically acquiring data, but the registered site may be stored by the user manually inputting data into a navigation system or the like. Further, for example, conditions for setting the registered site may be defined in advance. For example, a condition for the setting of the registered site is whether or not there is geographic location data set in the navigation of the external terminal 3 and/or the vehicle 2. If it is determined that there is no geographic location data, the storage unit 20 may use information recorded in the vehicle 2, such as POIs selected based on the travel history, to store, as the registered site, the location of a POI with a high frequency of travel or drop-by.

The abnormality detection unit 30 acquires vehicle data from the vehicle 2 and detects an abnormality in the vehicle 2. The vehicle data is data indicating the state of the vehicle 2, and specifically, is the result of detecting the state of each part detected by a sensor installed in the part of the vehicle 2. The abnormality detection unit 30 acquires, for example, time-series data including engine rotation speed and engine temperature, as vehicle data. Based on the vehicle data, the abnormality detection unit 30 then determines whether or not the vehicle 2 breaks down or whether or not the vehicle 2 is likely to break down in near future. Specifically, the abnormality detection unit 30 determines whether or not an outlier from a threshold value for each sensor signal under a preset detection condition has been detected based on the vehicle data. If an outlier is detected, the abnormality detection unit 30 determines that an abnormality in the vehicle 2 is detected. As the detection condition, for each sensor signal acquired from the vehicle data, a corresponding fault code and the threshold value for the sensor signal are set. For example, if the detected value is outside a threshold value set within a predetermined range, the abnormality detection unit 30 determines that an outlier has been detected.

Further, the abnormality detection unit 30 may perform invariant analysis. In invariant analysis, the abnormality detection unit 30 constructs a model of the relationship between a plurality of sensor signals from the vehicle data in a normal state, and compares values predicted by the model with actual measured values to detect whether or not the model of the relationship collapses. Further, the abnormality detection unit 30 may use machine learning to determine whether the vehicle is in a normal state or an abnormal state based on vehicle data. Note that the method is not limited to any of the methods mentioned above, and any method may be used as long as it can detect an abnormality.

When the abnormality detection unit 30 detects an abnormality in the vehicle 2, the abnormal level determination unit 40 determines the abnormal level for the detected abnormality in the vehicle 2, and stores, as abnormal level data, the abnormal level determination result and a determination factor used for determining the abnormal level. The determination factor for determining the abnormal level may be a single factor or may include a plurality of factors. The determination factors include, for example, the abnormal type, the remaining distance to travel, and the remaining time to travel. Table 1 is an example of abnormal level determination based on each abnormal level determination factor.

TABLE 1

| Abnormal Level | Abnormal Level | |
|---|---|---|
| Determination Factor | Low | High |
| Abnormal Type | Engine Oil | Engine Breakdown |
| | Deterioration | |
| Remaining Distance to Travel | 100 km or More | Less than 100 km |
| Remaining Time to Travel | 3 Hours or More | Less than 3 Hours |

When determining the abnormal level according to the abnormal type, the abnormal level determination unit 40 determines the abnormal level to be “low” if the abnormality in the engine of the vehicle corresponds to the abnormal type “engine oil deterioration”. On the other hand, the abnormal level determination unit 40 determines the abnormal level to be “high” if the abnormality in the engine of the vehicle corresponds to the abnormal type “engine breakdown”. The abnormal level determination unit 40 may also calculate the remaining distance to travel or the remaining time to travel, and determine the abnormal level from the calculation result. The remaining distance/time to travel is a distance/time that the vehicle 2 can travel with the abnormality in the vehicle 2 not repaired. For example, if the remaining distance to travel is equal to or greater than a threshold value of 100 km, or if the remaining time to travel is equal to or greater than a threshold value of 3 hours, the abnormal level determination unit 40 determines that the abnormal level is “low”. If the remaining distance to travel is less than the threshold value of 100 km, or if the remaining time to travel is less than the threshold value of 3 hours, the abnormal level determination unit 40 determines that the abnormal level is “high”.

As an example of the method of determining the abnormal level, a method using the remaining distance to travel will be described. The remaining distance to travel represents a difference between a cumulative travel distance where the vehicle 2 traveling is expected to break down with the abnormality not repaired and a cumulative travel distance at the time when the abnormality was detected. For example, if the cumulative travel distance when the abnormality was detected is 1,200 km, and the cumulative travel distance where the vehicle 2 traveling is expected to break down with the abnormality in the vehicle 2 not repaired is 1,250 km, then the remaining distance to travel is 50 km. Then, the abnormal level determination unit 40 determines the abnormal level to be “high” if the remaining distance to travel is less than the threshold value, and determines the abnormal level to be “low” if the remaining distance to travel is equal to or greater than the threshold value.

For example, if the threshold value for the remaining distance to travel is 30 km and the remaining distance to travel is 50 km, the abnormal level is determined to be “low” because the remaining distance to travel of 50 km is greater than the threshold value of 30 km. On the other hand, if the threshold value for the remaining distance to travel is 30 km and the remaining distance to travel is 15 km, the abnormal level is determined to be “high” because the remaining distance to travel of 15 km is less than the threshold value of 30 km. In this case, the abnormal level determination unit 40 stores abnormal level data including “abnormal level: high” as the abnormal level determination result and “remaining distance to travel: 50 km” as the determination factor.

Note that the abnormal level determination unit 40 may perform the determination using a plurality of determination criteria and threshold values. For example, if the cumulative travel distance is 100,000 km or more, the threshold value for the remaining distance to travel may be set to 10 km because if the cumulative travel distance is long, the vehicle is likely to break down. Further, if the cumulative travel distance is between 1,000 and 100,000 km, the threshold value for the remaining distance to travel may be set to 20 km, and if the cumulative travel distance is 1,000 km or less, the threshold value for the remaining distance to travel may be set to 30 km. Further, the threshold value for the remaining distance to travel may be set according to a bathtub curve of failure. Specifically, based on the fact that the failure rate increases immediately after the vehicle 2 starts traveling and when parts have deteriorated after a certain period of time, for the early stage of travel, for example, for a cumulative travel distance of 1,000 km or less, and for the later stage of travel, for example, for a cumulative travel distance of 100,000 km or more, the threshold value for the remaining distance to travel is set to 10 km. Further, for a cumulative travel distance between 1,000 and 100,000 km, the threshold value for the remaining distance to travel is set to 30 km.

Note that the methods and values described above are just examples, and the methods and values are not limited thereto, and any method and value may be used as long as they are a method for determining the abnormal level and a suitable value. For example, the abnormal level determination unit 40 is not limited to acquiring the vehicle data from the vehicle 2, and may acquire vehicle data from a device or database outside of the vehicle. For example, the external device is a sensor device of a traffic infrastructure installed on a road or a sensor device of a vehicle other than the vehicle 2. Further, the vehicle data may be acquired from a database stored in the external device. Further, although the abnormality detection unit 30 and the abnormal level determination unit 40 are provided in the server 1, they are not limited thereto, and the abnormality detection unit 30 and the abnormal level determination unit 40 may be provided in the vehicle 2. Specifically, in the vehicle 2, the abnormality detection unit 30 may detect a predetermined abnormality in the vehicle 2 based on the vehicle data, and the abnormal level determination unit 40 may determine the abnormal level for the detected predetermined abnormality. Then, the vehicle 2 transmits data indicating the determined abnormal level to the server 1.

The abnormal level input unit 50 receives an input of data indicating the abnormal level determined by the abnormal level determination unit 40 as an abnormal level determination result. Further, in a case where the abnormal level is determined in the vehicle 2, the abnormal level input unit 50 receives an input of data indicating the abnormal level transmitted from the vehicle 2.

The repair route calculation unit 60 calculates a repair route to a repair site. A single repair route or a plurality of repair routes may be calculated. The repair route calculation unit 60 includes a site location data acquisition unit 61, a repair site data acquisition unit 62, and a route calculation unit 63. The site location data acquisition unit 61 identifies the departure site and waypoints on the repair route by using the current location data of the vehicle 2 acquired by the location acquisition unit 10 and the location data of the registered site stored in the storage unit 20, and acquires location data of the departure site and waypoints on the repair route. For example, the site location data acquisition unit 61 acquires, as the location data of the departure site, the current location of the vehicle 2 or the location of the user's home, which is the registered site.

Further, if the destination of the travel plan is stored as the registered site, the site location data acquisition unit 61 acquires the location of the destination of the vehicle 2 as the location data of a waypoint. This is because in a case where the abnormal level of the detected abnormality in the vehicle 2 is low and the destination is set in the car navigation as the travel plan of the vehicle 2, there are times when the user wishes to go to a repair site from the destination after moving from the current location to the destination.

Further, the repair site data acquisition unit 62 acquires the location data of a repair site based on the location data of the departure site and waypoints acquired by the site location data acquisition unit 61. The repair site data acquisition unit 62 identifies the repair site starting from the current location or the registered site identified as the departure site and the waypoint, and acquires repair site data including the location data of the repair site. Further, the route calculation unit 63 calculates a repair route from the departure site to the repair site via the waypoints based on the departure site and waypoint data and the repair site data. In the present embodiment, the route calculation unit 63 calculates a repair route including the current location of the vehicle 2 as the departure site and a repair route including the registered site as the departure site. The route calculation unit 63 may also calculate a repair route including the current location of the vehicle 2 as the departure site and the registered site as a waypoint.

The repair site acquisition unit 70 determines a repair site to be presented to the user based on the abnormal level, and acquires repair site data of the determined repair site. The repair site data includes, for example, location data of the repair site and the name of the repair service provider. The repair site acquisition unit 70 includes an acquisition information determination unit 71. The acquisition information determination unit 71 determines whether or not to acquire repair site data of a repair site starting from the registered site. For example, if the abnormal level is “low”, the acquisition information determination unit 71 determines a repair site starting from the registered site as a repair site to be acquired, and acquires the repair site data of the repair site. Further, if the abnormal level is “high”, the acquisition information determination unit 71 determines a repair site starting from the current location of the vehicle 2 as a repair site to be acquired, and acquires repair site data of the repair site. Further, the acquisition information determination unit 71 selects a repair route to the repair site to be acquired from among a plurality of repair routes calculated by the repair route calculation unit 60. A plurality of repair routes may be selected for one repair site.

For example, if the repair site acquisition unit 70 determines a repair site starting from the current location as the repair site to be acquired, the repair site acquisition unit 70 selects a plurality of repair routes starting from the current location and traveling to the repair site. If the repair site acquisition unit 70 determines a repair site starting from the registered site as the repair site to be acquired, the repair site acquisition unit 70 selects a plurality of repair routes starting from the registered site and traveling to the repair site. Further, if the abnormal level is “low”, the repair site acquisition unit 70 may select a repair route for a repair site starting from the current location in addition to the repair site starting from the registered site. Further, in a case where there are a plurality of repair routes to be presented, the acquisition information determination unit 71 determines the priority for the repair routes to be presented. For example, the acquisition information determination unit 71 may determine the priority in ascending order of distance from the departure site, may use a factor used in determining the abnormal level, such as a distance to travel, or may use evaluation data posted on the Internet, such as the descending order of word-of-mouth evaluation for repair sites. Further, the factor for selecting a route to be presented and determining the priority may be a single factor or may include a plurality of factors.

The transmission unit 80 transmits the repair site data of the repair site acquired by the repair site acquisition unit 70 to the vehicle 2 and/or the external terminal 3. The repair site data includes location data of the repair site and the name of the repair service provider. The repair site data also includes the repair route to the repair site selected by the repair site acquisition unit 70, a travel distance of the repair route, and the priority of the repair route. Further, the transmission unit 80 transmits, as abnormal level data, the abnormal level determination result and the determination factor to the vehicle 2 and/or the external terminal 3. The transmission unit 80 also transmits a control instruction to display the repair site data and the abnormal level data as well as the repair site data and the abnormal level data to the vehicle 2 and/or the external terminal 3.

The external terminal 3 is, for example, a terminal of the user, and the external terminal 3 may be a single external terminal or may include a plurality of external terminals. With the above configuration, the repair site transmission device 100 according to the present invention can switch and present routes to be presented according to the abnormal level. As a result, even in cases where the conditions of deterioration of parts cannot be ascertained without going to a specific location such as a gas station, the user can see the presented abnormal level data and understand the level of urgency to respond to the abnormality. Further, when an abnormality that requires urgent response has been detected, the user can see the route from the current location, preventing the user from selecting repair at a later date and preventing the vehicle from breaking down before the vehicle travels to a repair shop and thus becoming unable to travel on a road. Further, when there is no abnormality that requires urgent response, a route in which the user's home or the destination of the vehicle 2 is set as the departure site or a waypoint is presented, so that the user can select a repair site according to the user's convenience, improving the usability.

Next, the vehicle 2 will be described. The vehicle 2 is an automobile with a navigation device installed, and is also a manned automobile for which travel control is performed automatically or manually. Further, in a case where the vehicle 2 is a vehicle managed by a business operator that is a user, such as a car-share vehicle, it may be an unmanned vehicle that can be controlled to travel automatically. The vehicle 2 includes the navigation device, which based on the current location of the vehicle 2 and a user's input, sets a travel route from a departure site to a destination, and presents route guidance to the user. For example, the navigation device displays a map, the current location of the vehicle 2, the location of the destination, and the travel route on a display provided in the navigation device.

Further, when repair site data of a repair site and abnormal level data are acquired from the repair site transmission device 100, the navigation device displays the repair site data and the abnormal level data on the display. The navigation device may also output the repair site data and the abnormal level data using audio information. The vehicle 2 includes a GPS, which detects the current location of the vehicle 2, and transmits the current location to the repair site transmission device 100 at regular intervals. The vehicle 2 also includes in-vehicle sensors that detect the states of the respective parts of the vehicle 2, and transmits vehicle data indicating the state of the vehicle detected by the in-vehicle sensor to the repair site transmission device 100 at regular intervals. The vehicle 2 also records a travel history including information on a POI which is the travel destination, and transmits the travel history to the repair site transmission device 100.

Next, the external terminal 3 will be described. The external terminal 3 receives an input of information from the user and outputs the information to the user. The external terminal 3 acquires geographic location data input by the user and transmits the geographic location data to the repair site transmission device 100. For example, if the user has input the location of the user's home or workplace and the location of a destination for which the user plans to go out into an installed map/local application, the external terminal 3 acquires geographic location data of these locations. Further, if the user has input the location of a destination for which the user plans to go out as the user's schedule into an installed schedule management application, the external terminal 3 acquires geographic location data of the destination of the user's plan. Further, when the external terminal 3 acquires repair site data and abnormal level data from the repair site transmission device 100, the external terminal 3 displays the repair site data and the abnormal level data on the display. The external terminal 3 may also output the repair site data and the abnormal level data using audio information.

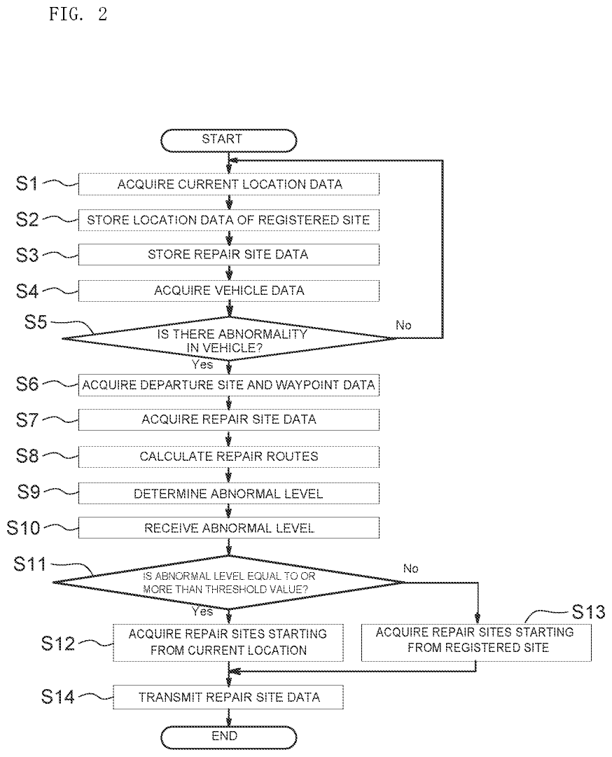

Next, an example of a repair site transmission method performed by the repair site transmission device 100 according to the present embodiment will be described with reference to FIG. 2. FIG. 2 is a flowchart illustrating a procedure according to Example 1 of the repair site transmission method. In step S1, the location acquisition unit 10 in the server 1 acquires current location data of the vehicle 2. In step S2, the storage unit 20 in the server 1 stores location data of the registered site. In step S3, the repair route calculation unit 60 in the server 1 stores the repair site data. In step S4, the abnormality detection unit 30 in the server 1 acquires the vehicle data.

In step S5, the server 1 determines whether or not there is an abnormality in the vehicle 2. For example, the server 1 determines, based on the vehicle data of the vehicle 2, whether or not the vehicle 2 breaks down or whether or not the vehicle 2 is likely to break down in near future, and if it is determined that the vehicle 2 breaks down or the vehicle 2 is likely to break down, the server 1 detects an abnormality in the vehicle 2. When the abnormality in the vehicle 2 is detected, the server 1 proceeds to step S6. When no abnormality in the vehicle 2 is detected, the server 1 proceeds to step S1 to repeat the following flow. In other words, the server 1 acquires the current location of the vehicle 2 at predetermined intervals, stores the registered site and the repair site, and acquires the vehicle data until an abnormality in the vehicle 2 is detected. When the registered site is changed, the server 1 updates the registered site to the changed registered site.

In step S6, the repair route calculation unit 60 in the server 1 acquires the current location data of the vehicle 2 and/or the location data of the registered site at the time when the abnormality of the vehicle 2 was detected. Then, the server 1 acquires the current location data of the vehicle 2 and/or the location data of the registered site as location data of the departure site and/or the waypoint on the repair route. In step S7, the server 1 searches for a plurality of repair sites within a predetermined range from the departure site and/or the waypoint based on the location data of the departure site and/or the waypoint, and acquires repair site data of the repair sites searched for. In step S8, the server 1 calculates a repair route to travel to each repair site acquired in step S7. The server 1 calculates a repair route to the repair site starting from the current location, and calculates a repair route to the repair site starting from the registered site. In step S9, the abnormal level determination unit 40 in the server 1 determines the abnormal level for the abnormality of the vehicle 2 detected by the abnormality detection unit 30. In step S10, data indicating the abnormal level determined in step S9 is input to the server 1.

In step S11, the repair site acquisition unit 70 in the server 1 determines whether or not to acquire a repair site starting from the registered site. Specifically, the server 1 determines, based on the determination result in step S9, whether or not the abnormal level is equal to or greater than a threshold value. Further, the server 1 may determine whether the abnormal level is high or low. If it is determined in step S11 that the abnormal level is equal to or greater than the threshold value, the server 1 proceeds to step S12. In step S12, the server 1 determines a repair site starting from the current location as the repair site to be presented to the user, and acquires the determined repair site data. Then, the server 1 selects a repair route, limited to a repair route with the current location as the departure site, from among the routes calculated by the repair route calculation unit 60. A plurality of repair routes starting from the current location may be acquired as selected, or a plurality of repair routes for the repair site within the range where the vehicle 2 can travel (not broken while traveling) may be acquired as selected, as long as they are repair routes with the current location as the departure site. If a plurality of routes are selected, the priority for the repair routes is determined.

On the other hand, if it is determined in step S11 that the abnormal level is less than the threshold value, the server 1 proceeds to step S13. In step S13, the server 1 preferentially acquires the repair site data of a repair site with the registered site as the departure site. The server 1 selects a repair route to the repair site starting from the registered site. Note that the repair route that is preferentially acquired for a low abnormal level may be a repair route that reaches the repair site from the current location via the registered site. Further, as the repair route acquired for a low abnormal level, a repair route that travels from the current location as the departure site to the repair site may be acquired as well as the repair route that travels from the current location to the repair site via the registered site. In the present embodiment, the server 1 selects a repair route, calculates the travel distance of the repair route, and determines the priority for the repair route.

In step S14, the transmission unit 80 in the server 1 transmits, as repair site data, the location data of the repair site, the repair route to the repair site, the travel distance of the repair route, and the priority of the repair route to the vehicle 2 and/or the external terminal 3. Further, the transmission unit 80 in the server 1 transmits, as abnormal level data, the abnormal level determination result and the determination factor to the vehicle 2 and/or the external terminal 3. Further, the transmission unit 80 in the server 1 transmits, to the vehicle 2 and/or the external terminal 3, a control instruction to display the repair site data and the abnormal level data to the user.

Note that the server 1 in the present embodiment acquires data on the current location of the vehicle 2 and the registered site before an abnormality in the vehicle 2 is detected, but the timing of acquiring the data is not limited thereto. The server 1 may acquire data on the current location of the vehicle 2 and the registered site after the abnormal level is determined. For example, for a high abnormal level, the server 1 may acquire the current location data, specify a repair site starting from the current location, and calculate a repair route to the specified repair site. Further, the server 1 in the present embodiment calculates a repair route starting from the current location and a repair route starting from the registered site before the abnormal level is determined, but the timing of calculating the repair route is not limited thereto. After the abnormal level is determined, the server 1 may calculate a repair route to a repair site according to the abnormal level based on the abnormal level.

A specific example of presenting repair sites to be switched based on an abnormal level determination result will now be described. The server 1 acquires a repair site based on an abnormal level determination result, and selects a repair route to the repair site. Further, the server 1 determines the priority for the repair site, and transmits repair site data including the priority of the repair site to the vehicle 2 and/or the external terminal 3 to present the repair site data to the user through the vehicle 2 and/or the external terminal 3. For a high abnormal level, the server 1 presents a repair route from the current location to the repair site to the user through the vehicle 2 and/or the external terminal 3. At that time, the server 1 may present repair site data of a plurality of repair sites as repair sites around the current location. For example, the server 1 selects a repair site in ascending order of distance from the current location (departure site), and presents a repair route to the repair site and the travel distance of the repair route.

Specifically, if the repair site closest to the current location is repair shop A, the server 1 presents a repair route from the current location to repair shop A with repair shop A being the highest priority repair site, and presents the travel distance (for example, 2.3 km) of the repair route. Further, if the second closest repair site to the current location is repair shop B, the server 1 presents a repair route from the current location to repair shop B with repair shop B being the second recommended repair site, and presents the travel distance (for example, 3.3 km) of the repair route. Furthermore, if the third closest repair site to the current location is repair shop C, the server 1 presents a repair route from the current location to repair shop C with repair shop C being the third recommended repair site, and presents the travel distance (for example, 3.7 km) of the repair route.

On the other hand, for a low abnormal level, the server 1 does not limit the route to be presented, but preferentially presents a repair route from the registered site as the departure site to the repair site. For example, if the registered site is shopping mall D, which is the destination of the vehicle 2 registered in the car navigation, the server 1 may present a repair route that travels from shopping mall D as the departure site of the repair route to a repair site near shopping mall D. The server 1 may present a repair route that travels from the current location to a repair site near shopping mall D via shopping mall D as a waypoint of the repair route. Further, assuming that the vehicle 2 is to be repaired on another day, the server 1 may present a repair route that travels from the current location to a repair site near the home via shopping mall D as the first waypoint and via the home as the second waypoint. Furthermore, in a case where the user of the vehicle 2 is a ride-hailing service provider or rental car company, the server 1 may set, as a registered site, a repair shop or office with which the ride-hailing service provider or car rental company has a contract, for example.

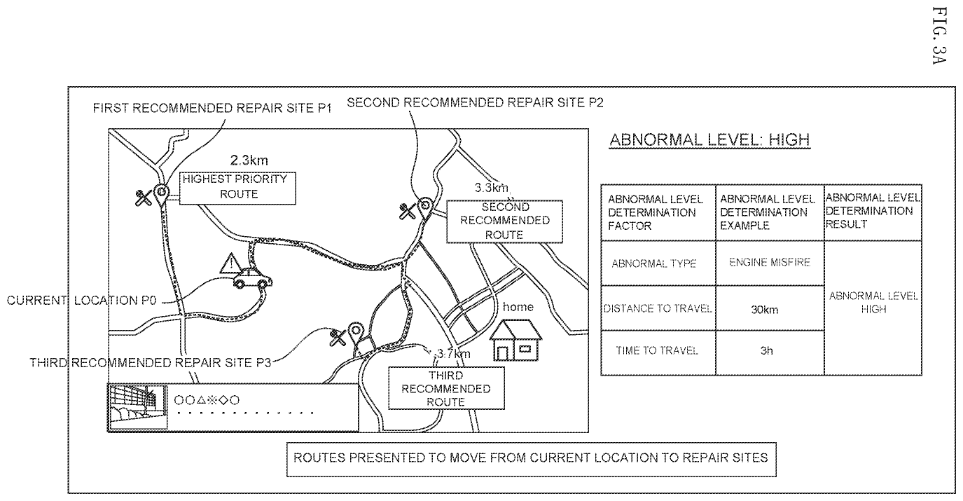

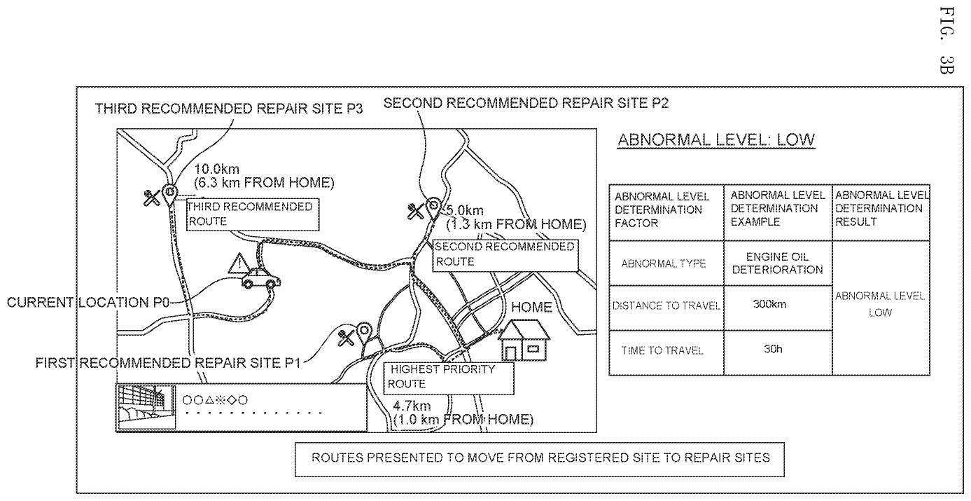

Next, display examples to be displayed on the display of the vehicle 2 and/or the external terminal 3 in Example 1 will be described with reference to FIGS. 3A and 3B. FIG. 3A is a display example of repair site data and abnormal level data, and is also an example for a high abnormal level, that is, for displaying repair sites starting from the current location and their respective repair routes. FIG. 3A illustrates a current location P0 of the vehicle 2, the location of the first recommended repair site P1, the location of the second recommended repair site P2, the location of the third recommended repair site P3, repair routes from the current location P0 to the respective repair sites, and the travel distances of the respective repair routes. Further, a repair route to the first recommended repair site P1 is displayed as the highest priority route, a repair route to the second recommended repair site is displayed as the second recommended route, and a repair route to the third recommended repair site is displayed as the third recommended route. Thus, priority data for each repair site are presented. Further, as a display example of abnormal level data, for example, abnormal level determination factors including abnormal type, distance to travel, and time to travel, and abnormal level determination results are displayed.

FIG. 3B is a display example of repair site data and abnormal level data, and is also an example for a low abnormal level, that is, for displaying repair sites starting from the registered site. The registered site is the user's home. FIG. 3B illustrates a current location P0 of the vehicle 2, the location of the first recommended repair site P1, the location of the second recommended repair site P2, the location of the third recommended repair site P3, repair routes from the current location P0 to the respective repair sites, and the travel distances of the respective repair routes. Further, a repair route to the first recommended repair site P1 is displayed as the highest priority route, a repair route to the second recommended repair site is displayed as the second recommended route, and a repair route to the third recommended repair site is displayed as the third recommended route. Thus, priority data for each repair site are presented. Further, as a display example of abnormal level data, for example, abnormal level determination factors including abnormal type, distance to travel, and time to travel, and abnormal level determination results are displayed.

As described above, in the present embodiment, a registered site registered based on information acquired from a vehicle or a user of the vehicle is stored: an input of data indicating an abnormal level associated with a predetermined abnormality of the vehicle is received: whether or not to acquire repair site data of a repair site where a part of the vehicle in which the predetermined abnormality is detected is to be repaired or to be replaced, starting from the registered site, is determined based on the abnormal level; the repair site data of the determined repair site is acquired; and the acquired repair site data is transmitted to an external device. This makes it possible to provide a user with information on a repair site according to the abnormal level of a vehicle.

Further, in the present embodiment, the current location of the vehicle is acquired, and whether to acquire repair site data of a repair site starting from the registered site or to acquire repair site data of a repair site starting from the current location is determined based on the abnormal level. This makes it possible to switch the repair sites to be presented to the user depending on the magnitude of the risk of the abnormality in the vehicle.

Further, in the present embodiment, the registered site is a site input by the user, a destination, departure site, or waypoint of the vehicle, a site based on a past travel history of the vehicle, or a business site where the vehicle is managed. This makes it possible to present a variety of repair sites that match the user's action plan, reducing unnecessary travel, and thus reducing the risk of breakdown of the vehicle traveling.

Further, in the present embodiment, the site input by the user is a site input into a schedule managed by the user. This makes it possible to reduce the man-hours required for the user to set navigation settings, prevent the registered site from being hidden due to the user forgetting to register it, reduce unnecessary travel, and thus reduce the risk of breakdown of the vehicle traveling.

Further, in the present embodiment, when the abnormal level is less than a predetermined value, the repair site acquisition unit acquires the repair site data of the repair site starting from the registered site. This makes it possible to present a variety of routes that match the user's action plan, reducing unnecessary travel, and thus reducing the risk of breakdown of the vehicle traveling.

Further, in the present embodiment, when the abnormal level is equal to or more than the predetermined value, the repair site data of the repair site starting from the current location is acquired. This allows the user to recognize that the abnormality in the vehicle is highly urgent and that the vehicle is required to go immediately to the repair site from the current location, and accordingly to select an appropriate response depending on the level of urgency.

Further, in the present embodiment, the abnormal level is the severity of the abnormality according to the abnormal type of the abnormality. This makes it possible to determine the abnormal level based on various factors and thus improve the accuracy of abnormal level determination.

Further, in the present embodiment, the abnormal level is set based on a travel condition that is a distance by, time for, or range in which the vehicle can travel with the abnormality not repaired. This makes it possible to determine the abnormal level based on various factors and thus improve the accuracy of abnormal level determination.

Further, in the present embodiment, a priority for the repair site is determined based on the abnormal level in ascending order of distance from the registered site or the current location, and the repair site data including the priority is transmitted to the external device. This allows the user to understand which repair site has a high priority, thereby reducing unnecessary travel and thus reducing the risk of breakdown of the vehicle traveling.

Further, in the present embodiment, vehicle data of the vehicle is acquired from a device or database outside of the vehicle in which the abnormality is detected, and the abnormal level is determined based on the acquired vehicle data. Thus, the abnormal level is determined based not only on data acquired from the vehicle but also on data acquired from outside the vehicle, so that the accuracy of abnormal level determination can be improved.

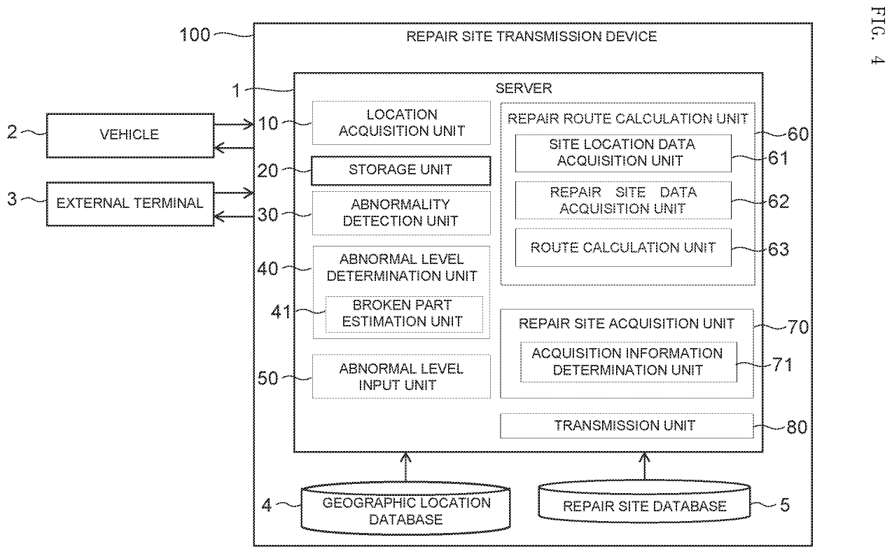

Next, Example 2 of the present embodiment will be described with reference to FIGS. 4 to 6. FIG. 4 is a block configuration diagram of a repair site transmission device according to the present example. Example 2 is a modification of the present embodiment. Example 2 has the same configuration as Example 1, and operates in the same manner as Example 1, except for the following points that differ from the repair site transmission device according to Example 1, and the description of Example 1 is used as appropriate. A configuration different from Example 1 will be described below. The configuration of the present example differs from that of Example 1 in that the abnormal level determination unit 40 includes a broken part estimation unit 41. Specifically, in Example 2, in addition to determining the abnormal level, the server 1 estimates a target part of the vehicle 2 where an abnormality occurs. This allows the user to better understand the level of urgency to respond to the abnormality in the vehicle 2 and the severity of the breakdown, and allows the user to trust the abnormality prediction results of the prediction system.

In Example 2, when the abnormality detection unit 30 detects an abnormality in the vehicle, the broken part estimation unit 41 in the abnormal level determination unit 40 estimates a broken part where the abnormality may occur. The broken part estimation unit 41 estimates a broken part from the vehicle data or the abnormal level determination factor (for example, the remaining distance to travel, etc.), and stores broken part data indicating the estimated broken part. In addition to broken parts, the targets to be estimated may include something that indicates a broken portion or region to be expected, and a response at a repair base (for example, disassembling parts to remove foreign objects), such as vehicle components (oil pan drain bolt (=drain plug)) and a dealer's response for repair (replenishment of engine oil). Further, the broken part estimation unit 41 may perform estimation using both the vehicle data and the abnormal level determination factor, or may perform estimation using either one of them. Further, the parts to be estimated are not limited to broken parts, but may be parts whose replacement time has passed, for example.

An example of estimating a broken part will now be described. As an example of a method of estimating a broken part, an estimation method will be described in a case where a plurality of abnormal level determination factors are used. Given are now two abnormal level determination factors: “abnormal type” and “remaining distance to travel”. In this case, it is assumed that the abnormal type is “engine misfire” and the remaining distance to travel is 80 km. The broken parts that are considered to be the cause of the abnormal type “engine misfire” include a “spark plug”, an “injector”, and an “airflow sensor”. The broken part estimation unit 41 identifies, as broken part candidates, parts that may be the cause of the abnormal type “engine misfire” from among the broken part candidates associated with the abnormal type of the detected abnormality.

Then, for the three parts, the broken part estimation unit 41 estimates a broken part from among the three parts by, for example, comparing a statistically derived value of the timing at which a sign of breakdown appears in signals of the vehicle 2 with the remaining distance to travel. For example, for the three parts, it is assumed that in a case where an engine misfire may occur in near future, the timing (abnormality detection point) at which a sign of engine misfire will appear as a change in the behavior of signals of the vehicle 2 will be within 30 km for the spark plug before being broken, within 75 km for the injector before being abnormal, and within 150 km for the airflow sensor before being abnormal. In this case, the broken part estimation unit 41 estimates, as a broken part, the injector for which the abnormality detection point is nearest to the remaining distance to travel of 80 km.

Further, as another example, the broken part estimation unit 41 may estimate a broken part or a response at the repair site based on the abnormal type. For example, assuming that the abnormal type is “engine oil deterioration”, the broken part estimation unit 41 may estimate “engine oil replacement” based on the abnormal type “engine oil deterioration”. Further, for example, assuming that the abnormal type is “engine misfire”, the broken part estimation unit 41 may estimate “injector replacement” based on the abnormal type “engine misfire”. The broken parts to be estimated based on abnormal types are stored in association with each abnormal type. Any number of abnormal level determination factors may be used to estimate a broken part. Further, the method described above is one method and is not limited thereto, and any method may be used as long as it is a method of estimating a broken part. Further, the abnormal level determination unit 40 may process the estimation of a broken part and the determination of the abnormal level simultaneously, or may perform one of them first and then the other.

The transmission unit 80 transmits, to the vehicle 2 and/or the external terminal 3, broken part data indicating the estimated broken part in addition to the repair site data and the abnormal level data. Further, the transmission unit 80 transmits a control instruction to display the broken part data to the vehicle 2 and/or the external terminal 3. With the above configuration, the repair site transmission device 100 according to the present invention not only presents routes to be switched according to the abnormal level, but also presents the estimated broken part, so that the user can more specifically understand the level of urgency to respond to the abnormality and the severity of breakdown.

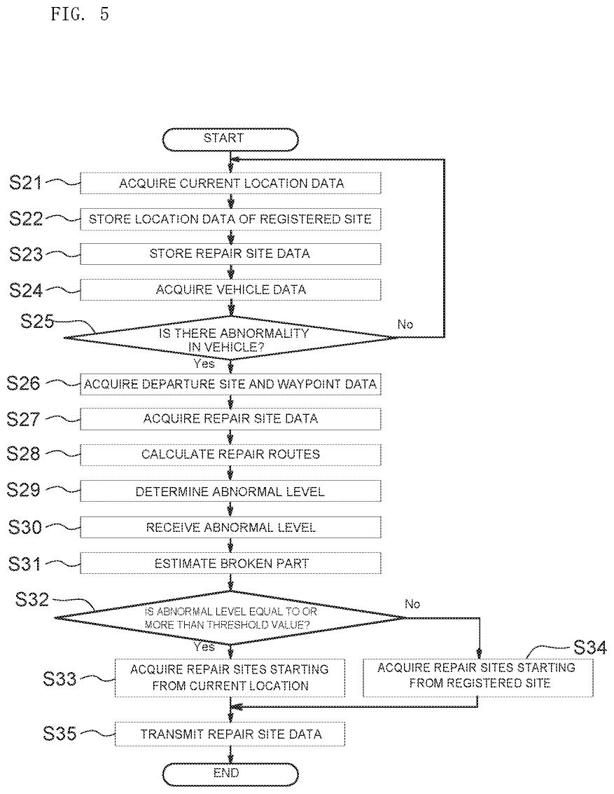

Next, a repair site transmission method performed by the repair site transmission device according to Example 2 will be described with reference to FIG. 5. FIG. 5 is a flowchart illustrating a procedure of the repair site transmission method according to Example 2. In the flowchart of FIG. 5, steps S21 to S30 and steps S32 to S34 are the same as in Example 1, thus repeated descriptions will be omitted, and the descriptions already given will be used. Step S31 and step S35 will be described below. In step S31, the abnormal level determination unit 40 in the server 1 estimates a broken part in which an abnormality is likely to occur in response to the abnormality detection unit 30 detecting the abnormality. Further, when the server 1 acquires the repair site data in step S33 or 34, in step S35, the server 1 transmits, to the vehicle 2 and/or the external terminal 3, broken part data indicating the broken part estimated in step S31 in addition to the repair site data and the abnormal level data.

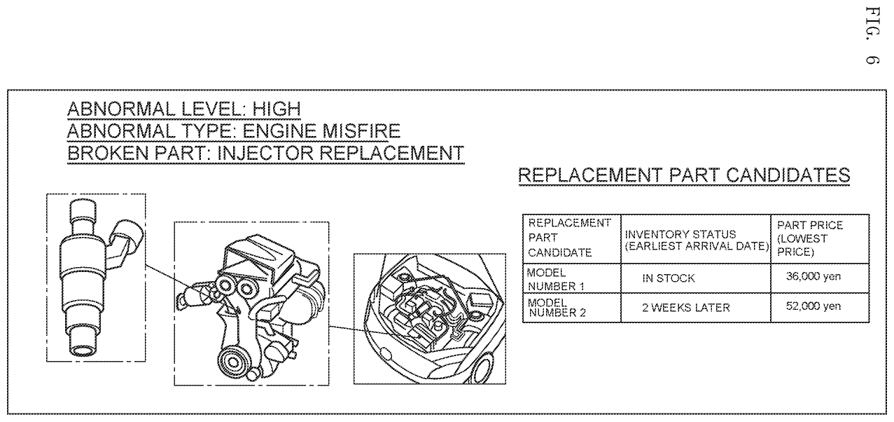

Next, a display example to be displayed on the display of the external terminal 3 and/or the vehicle 2 in Example 2 will be described with reference to FIG. 6. FIG. 6 is a display example of broken part data. For example, as illustrated in FIG. 6, a broken part included in the broken part data and a point and the location of the broken part in the vehicle are displayed in addition to the abnormal level and the abnormal type. Further, the part numbers or model numbers that are candidates for replacement part to replace the broken part, and the inventory status and part price of each candidate for replacement part may be displayed.

As described above, in the present embodiment, a target part where an abnormality may occur is estimated, and a control instruction to display the target part is transmitted to the external device. This allows the user to more specifically understand the level of urgency to respond to the abnormality and the severity of breakdown.

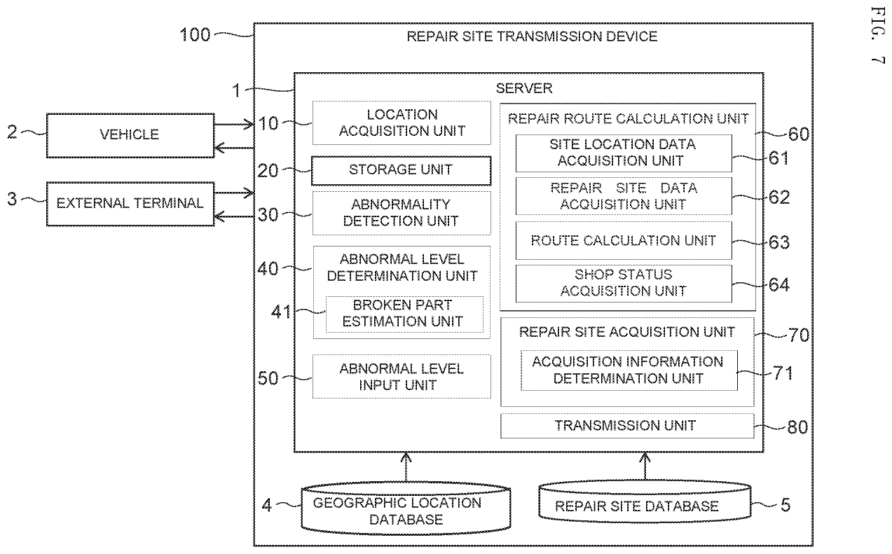

Next, Example 3 will be described with reference to FIGS. 7 to 9. FIG. 7 is a block configuration diagram of a repair site transmission device according to Example 3. Example 3 is a modification of the present embodiment. Example 3 has the same configuration as Example 2, and operates in the same manner as Example 2, except for the following points that differ from the repair site transmission device according to Example 2, and the description of Example 2 is used as appropriate. A configuration different from Example 2 will be described below. The configuration of the present example differs from that of Example 2 in that the repair route calculation unit 60 includes a shop status acquisition unit 64. Further, the repair site database 5 stores, for each repair site, shop status data of the repair site. For example, the shop status data is data indicating reservation status, part inventory status, and the like.

In Example 3, the shop status acquisition unit 64 acquires shop status data of the repair site whose data has been acquired by the repair site data acquisition unit 62. The elements of the shop status data as described below are examples, and the elements of the shop status data may include a repair cost and the presence or absence of optional services, provided by the corresponding shop. When the repair site data acquisition unit 62 acquires repair site data, the repair route calculation unit 60 selects, based on the shop status data, a repair site for which route calculation is performed.

The repair site acquisition unit 70 selects repair sites based on the abnormal level determined by the abnormal level determination unit 40, and then determines, based on the shop status data, repair sites to be presented to the user from among the selected repair sites. Further, the repair site acquisition unit 70 determines, based on the shop status data, the priority for each repair site to be presented to the user.

Given is now an example of selecting repair sites using the shop status data and determining a priority when it is determined that the abnormal level is high. If it is determined that the abnormal level is high, repair sites starting from the current location and their repair routes are presented. In this case, for example, the server 1 acquires, for each repair site, data on the availability of immediate response and/or wait time for repair from reservation status data included in the shop status data. Then, the server 1 selects repair sites to be presented to the user from among the repair sites from the current location to the repair site, based on the availability of immediate response and/or wait time for repair. For example, the server 1 selects, based on the reservation status, a repair site that can be reserved immediately or that can respond at the earliest possible time among repair sites within a range of distance by or time for which the vehicle can travel starting from the current location, and acquires repair site data of the selected repair site. Further, the server 1 determines the priority for each of the acquired repair sites based on the availability of immediate response and/or wait time for repair.

As an example of selecting repair sites and determining a priority, the travel distance from the current location to each repair site and the availability of immediate response or wait time for repair are given as Table 2 below.

TABLE 2

| | Travel Distance from | |
|---|---|---|
| Repair Shop Name | Current Location | Shop Status |
| Repair Shop A | 2.3 km | 3 Hour Wait Time |
| Repair Shop B | 3.3 km | Immediate Response |
| | | Available |
| Repair Shop C | 3.7 km | Not Available on |
| | | the Day |

In Example 3, the server 1 determines the highest priority for a repair site that can respond immediately. Further, if there is a wait time, the server 1 prioritizes the priority in ascending order of wait time. In this example, the repair sites are prioritized in order of repair shop B, repair shop A, and repair shop C. Further, in the above example, since repair shop C is not available for immediate response, server 1 may exclude it from the repair sites to be presented to the user. Further, the method described above is one method and is not limited thereto, and any method may be used as long as it is a method of determining repair sites to be presented to the user and their priorities based on the shop status data.

Further, if it is determined that the abnormal level is low, the server 1 acquires shop status data of repair sites starting from the current location and the registered site, and determines repair sites to be presented to the user and their priorities based on the shop status data. Given is now an example of selecting repair sites using the shop status data and determining a priority when it is determined that the abnormal level is low. If it is determined that the abnormal level is low, the server 1 determines repair sites to be presented to the user and their priorities based on factors related to user satisfaction with the repair service, instead of the availability of immediate response. For example, factors related to user satisfaction include the inventory status of replacement parts for the repair service, the cost of repair, the presence or absence of optional services (for example, engine additives for oil changes), the cost of optional services, the length of period of time required for the repair (the period of time during which the user leaves the car), time efficiency, cost performance, and service quality.

An example will be given below in which the inventory status of a part of the vehicle 2 is taken into account in the shop status data. First, the server 1 acquires, for example, inventory status data of replacement parts for the broken part estimated by the broken part estimation unit 41. Then, among the repair sites starting from the registered site, the server 1 acquires, based on the inventory status, repair site data of a repair site that has the replacement part(s) in stock or requires the shortest number of days to receive the replacement part. The travel distance from the registered site and the inventory status of the replacement part for each repair shop are given as Table 3 below.

TABLE 3

| | Travel Distance from | |
|---|---|---|
| Repair Shop Name | Registered Site | Part Inventory Status |
| Repair Shop A | 2.3 km | 1 Week Wait Time |
| Repair Shop B | 3.3 km | In Stock |
| Repair Shop C | 3.7 km | 3 Week Wait Time |

In Example 3, the server 1 determines the highest priority for a repair site that has the replacement part(s) for the broken part in stock. Further, in a case of backorder, the server 1 prioritizes the repair sites in order of arrival time of that part. In this example, the repair sites are prioritized in order of repair shop B, repair shop A, and repair shop C. Accordingly, the server 1 determines the highest priority for repair shop B with an inventory status of in stock, determines repair shop A with an inventory status of 1 week wait time as the second candidate, and determines repair shop C with an inventory status of 3 week wait time as the third candidate. Further, for a repair shop in which an inquired part is not available, the server 1 may take this into consideration and exclude that repair shop from the repair shops for presenting routes.

Further, any method may be used to select repair sites and determine their priorities based on the shop status data. For example, if a repair shop near the current location has the corresponding part(s) in stock, the server 1 may give the highest priority to the inventory status of the part(s) and indicate the route from the current location to that repair shop as the highest priority route. Further, the method described above is one method and is not limited thereto, and any method may be used as long as it is a method of determining repair sites to be presented to the user and their priorities based on the shop status data.

The transmission unit 80 transmits, to the vehicle 2 and/or the external terminal 3, the shop status data in addition to the repair site data, the abnormal level data, and the broken part data. The shop status data includes the elements of shop status data used to determine the repair sites to be presented to the user and their priorities. With the above configuration, the repair site transmission device 100 according to the present invention can acquire shop status data such as shop reservation status and part inventory status, and present, to the user, repair sites and their priorities determined in consideration of the shop status. Since the user can select an available repair shop when visiting the shop, it makes it easier for the repair service provider to respond smoothly when the user visits the shop, so that the efficiency of repairs and maintenance can be improved.

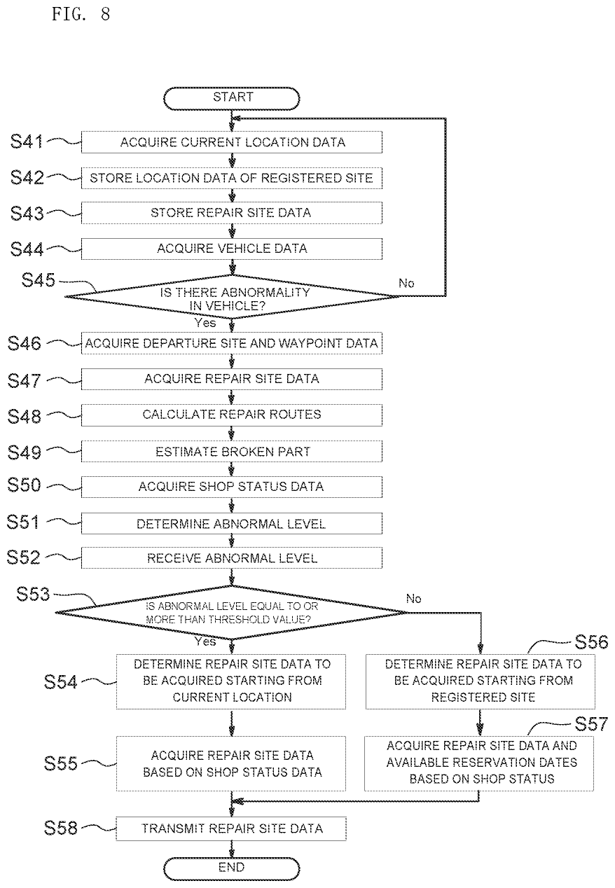

Next, a repair site transmission method performed by the repair site transmission device according to Example 3 will be described with reference to FIG. 8. FIG. 8 is a flowchart illustrating a procedure of the repair site transmission method according to Example 3. In the flowchart of FIG. 8, steps S41 to S48 and steps S51 to S53 are the same as in Example 1, thus repeated descriptions will be omitted, and the descriptions already given will be used. Steps S49 to S50 and steps S54 to S58 will be described below. After the repair route is calculated in step S48, the server 1 estimates a broken part in step S49.

In step S50, the server 1 acquires shop status data such as reservation status and/or part inventory status for each repair site whose repair site data is acquired in step S47. When acquiring part inventory status data, the server 1 may grasp the inventory status of the broken part estimated in step S49. Further, if a plurality of parts are estimated by the broken part estimation unit 41, or if a broken portion cannot be identified, the server 1 may refer to the inventory status of a part to be expected based on the abnormal type, for example, a database such as a list of stocked parts. The shop status data related to reservation status may be acquired for each of same-day reservation information and later-day reservation information, or may be acquired for all at once. Further, the reservation status to be acquired may include not only the schedule but also the time, and may include the time slots such as morning and afternoon, for example. Note that the shop status data to be acquired may be acquired in any categorization method such as yearly, monthly, daily, or time-slot-based, and the period for acquiring the data may be any period for acquiring the data as long as it can acquire the shop status data on the day.

In step S54, the server 1 determines repair site data to be acquired, starting from the current location. In step S55, the server 1 selects, based on the shop status data, repair sites to be presented to the user from among the repair sites starting from the current location, and acquires repair site data including the repair routes to the selected repair sites. Further, the server 1 determines the priorities for the repair sites based on the shop status data. In step S56, the server 1 determines repair site data to be acquired, starting from the registered site. In step S57, the server 1 selects, based on the shop status data, repair sites to be presented to the user from among the repair sites starting from the registered site, and acquires repair site data including the repair routes to the selected repair sites, and available reservation dates of the repair sites.

In step S58, the server 1 transmits the repair site data. When the repair site data and the available reservation date are acquired in step S57, the server 1 transmits the repair site data including: the location data of the repair sites, the repair routes to the respective repair sites, the travel distances of the respective repair routes, and their available reservation dates. Thus, it makes it easier for the repair service provider at each repair site to respond smoothly, so that the efficiency of repairs and maintenance can be improved.

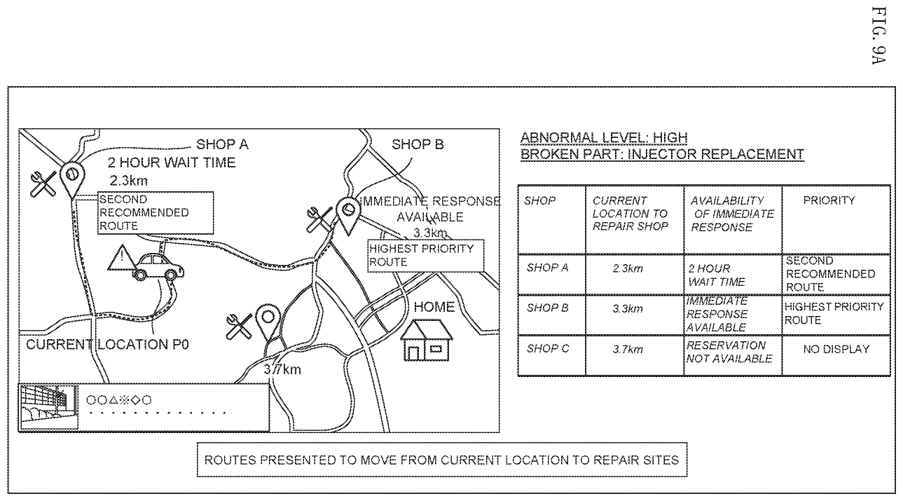

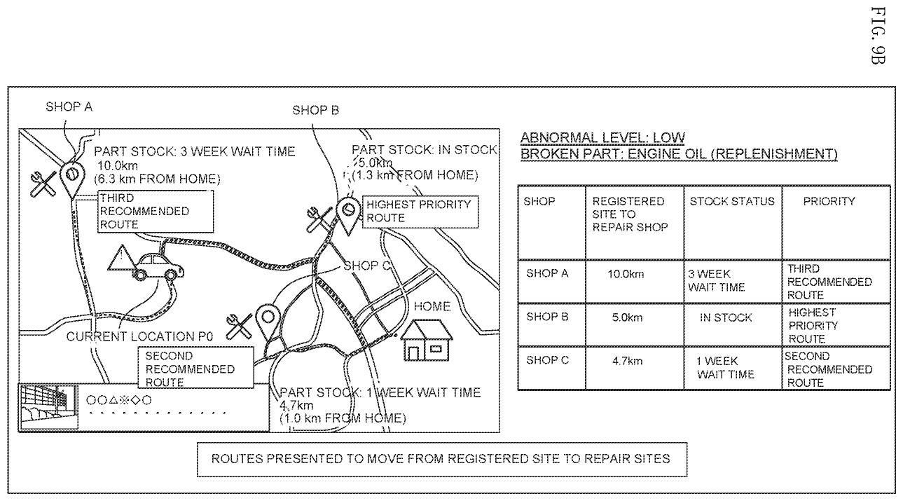

Next, display examples to be displayed on the display of the vehicle 2 and/or the external terminal 3 in Example 3 will be described with reference to FIGS. 9A and 9B. In FIGS. 9A and 9B, the repair site data of the repair sites selected in consideration of the shop status in Example 3, and the shop statuses and priorities of the presented repair sites are displayed. FIG. 9A is an example in which the repair site data of the repair sites starting from the current location is displayed. The repair site data includes: the location of each repair site, the repair route to the repair site, the travel distance of the repair route, and the priority of the repair route. The shop status data includes the availability of immediate response of each repair site. For example, the availability of immediate response of repair shop A is 2 hour wait time, the availability of immediate response of repair shop B is immediate response available, and the availability of immediate response of repair shop C is reservation not available. In FIG. 9A, shop B is displayed as the highest priority repair site, the repair route to shop B is displayed as the highest priority route, shop A is displayed as the second recommended repair site, and the repair route to shop A is displayed as the second recommended route. Shop C is not displayed because it is not available for immediate response.

Further, FIG. 9B is an example in which the repair sites starting from the registered site are displayed. The registered site is the user's home. The repair site data includes: the location of each repair site, the repair route to the repair site, the travel distance of the repair route, and the priority of the repair route. The shop status data includes the inventory status of the broken part. For example, the inventory status of repair shop A is 3 week wait time, the inventory status of repair shop B is in stock, and the inventory status of repair shop C is 1 week wait time. In FIG. 9B, shop B is displayed as the highest priority repair site, the repair route to shop B is displayed as the highest priority route, shop C is displayed as the second recommended repair site, the repair route to shop C is displayed as the second recommended route, shop A is displayed as the third recommended repair site, and the repair route to shop A is displayed as the third recommended route. Further, the shop status data may be switched depending on the result of determining the abnormal level, or all items of the acquired shop status data may be displayed.

As described above, in the present embodiment, the inventory status of replacement parts for the target part at each repair site is acquired, and if the abnormal level is less than the predetermined value, then the repair site data of a repair site that has the replacement part(s) in stock or requires the shortest number of days to receive the replacement part among the repair sites starting from the registered site is acquired based on the inventory status, and a control instruction to display the registered site is transmitted to the external device. This allows the user to select an appropriate repair site according to the inventory status of the replacement part.

Further, in the present embodiment, the current location of the vehicle is acquired, the reservation status of each repair site is acquired, and if the abnormal level is equal to or more than the predetermined value, then the repair site data of a repair site that can be reserved immediately or that can respond at the earliest possible time among repair sites within a range of distance by or time for which the vehicle can travel starting from the current location is acquired based on the reservation status, and a display instruction to display the repair site is transmitted to the external device. This allows the user to select an appropriate repair site according to the reservation status of each repair site.

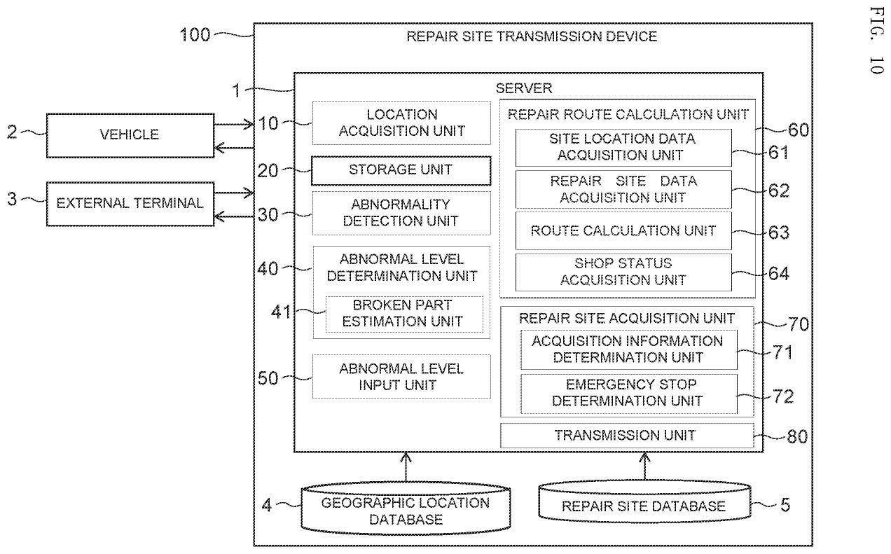

Next, Example 4 will be described with reference to FIGS. 10 to 12. FIG. 10 is a block configuration diagram of a repair site transmission device according to Example 4. Example 4 is a modification of the present embodiment. Example 4 has the same configuration as Example 3, and operates in the same manner as Example 3, except for the following points that differ from the repair site transmission device according to Example 3, and the description of Example 3 is used as appropriate. A configuration different from Example 3 will be described below. The configuration of the present embodiment differs from Example 3 in that the repair site acquisition unit 70 includes an emergency stop determination unit 72.

In Example 4, in a case where the abnormal level is so high that the vehicle 2 is likely to break down before the vehicle 2 reaches the repair site, the server 1 searches for an emergency stop site where the vehicle 2 can safely stop, and presents an emergency stop instruction to the user. The emergency stop instruction data includes: location data of the emergency stop site, a route to safely travel from the current location to the emergency stop site, and an emergency stop instruction to allow the vehicle 2 to travel to the emergency stop site. Thus, the vehicle 2 can safely stop before it breaks down, making it possible to prevent the vehicle 2 traveling from breaking down on a road. In the present embodiment, the case where the abnormal level is so high that the vehicle 2 is likely to break down before the vehicle 2 reaches the repair site is, for example, a case where the abnormal level is high and a distance by or a time for which the vehicle 2 can travel from the current location of the vehicle 2 at the time when the abnormality was detected is equal to or less than a threshold value.

If it is determined that the abnormal level is equal to or more than a predetermined value and a distance by or a time for which the vehicle can travel from the current location of the vehicle at the time when the abnormality was detected is equal to or less than a threshold value, the emergency stop determination unit 72 in the repair site acquisition unit 70 searches for an emergency stop site near the current location, and acquires emergency stop site data including location data of the emergency stop site. The threshold value for the distance to travel is, for example, 2 km. Further, the threshold value for the time to travel is 1 hour. The emergency stop site is a place where the vehicle can legally and safely stop. The emergency stop site includes, for example, a rest area with a parking lot such as a service area, a road shoulder in an area other than areas where parking is prohibited by law (no-parking areas), and a place that does not obstruct the passage of other vehicles. The repair site acquisition unit 70 also acquires a route from the current location to the emergency stop site.

Further, the emergency stop determination unit 72 may determine whether or not the vehicle can reach, using any of the repair routes calculated by the repair route calculation unit 60, the corresponding repair site before the vehicle breaks down. For example, if there is no repair site within the distance to travel, the emergency stop determination unit 72 determines that the abnormal level is so high that the vehicle cannot reach any repair site, searches for an emergency stop site near the current location, and acquires a route from the current location to the emergency stop site. Then, the emergency stop determination unit 72 searches for a repair shop or repair service that can visit the emergency stop site, and acquires data on the repair shop or repair service that can visit on site. The data on the repair shop or repair service that can visit on site includes, for example, location data and contact data of the repair shop and the like.

Given is now an example of determining whether or not the vehicle can reach a repair site. Examples of the travel distance from the current location to each repair site and the availability of immediate response or wait time of the repair site are the same as in Table 3 above. Further, this example includes an example in which the determination for an emergency stop instruction is performed using the “remaining distance to travel”. At this time, if the remaining distance to travel is 2 km, there is no shop to which the vehicle can move from the current location. Therefore, the server 1 searches for an emergency stop site near the current location. The emergency stop site may be, for example, a service area or a rest area on a highway, or for example, a road shoulder other than no-parking areas on a general road. Using the method described above, the server 1 determines whether or not the vehicle reaches each repair site, and if it is determined that the severity of the abnormality is so high that the vehicle cannot reach any of the repair sites, the server 1 acquires location data of an emergency stop site near the current location of the vehicle 2. Further, the method described above is one method and is not limited thereto, and any method may be used as long as it is a method of determining whether or not the vehicle 2 can reach a repair site.

The transmission unit 80 transmits, to the vehicle 2 and/or the external terminal 3, emergency stop instruction data in addition to the repair site data, the abnormal level data, the broken part data, and the shop status data. The emergency stop instruction data includes: location data of the emergency stop site, a route to the emergency stop site, information on a repair shop or repair service that can visit the emergency stop site, and a stop instruction to stop the vehicle 2 at the emergency stop site. With the above configuration, in a case where the abnormal level is so high that the vehicle breaks down before the vehicle reaches the repair site, the repair site transmission device 100 according to the present invention searches for a place where the vehicle can safely stop, and presents a route from the current location to such an emergency stop site. This allows the vehicle 2 to safely stop before the vehicle 2 breaks down, making it possible to prevent the vehicle 2 traveling from breaking down on a road. Further, in the present embodiment, by presenting information on a repair shop or repair service that can visit on site, the efficiency of any user's action after the vehicle stops can be improved.

Further, in the present embodiment, if the abnormal level is equal to or more than a predetermined value and a distance by or a time for which the vehicle can travel from the current location of the vehicle at the time when the abnormality was detected is equal to or less than a threshold value, the transmission unit 80 may contact an on-site repair service provider that can visit the emergency stop site and transmit data on the distance or time to travel of the vehicle 2 to the on-site repair service provider. For example, the on-site repair service provider is JAF or the like. For example, contacting the on-site repair service provider includes connecting a call with the on-site repair service provider and requesting assistance through an application. This allows the user to efficiently share a travel range for the vehicle 2 to stop in the contact with the on-site repair service provider to request on-site repair to the on-site repair service provider, thereby making it possible to quickly find a meeting site. Further, when the contact with the on-site repair service provider is performed through the transmission unit 80, the storage unit 20 identifies a meeting site between the user and the on-site repair service provider based on the speech in the call between the user of the vehicle 2 and the on-site repair service provider, and stores, as the registered site, the meeting site between the user and the on-site repair service provider. For example, the storage unit 20 identifies a meeting site by using voice recognition to extract keywords related to the meeting site from the voice of the speech.

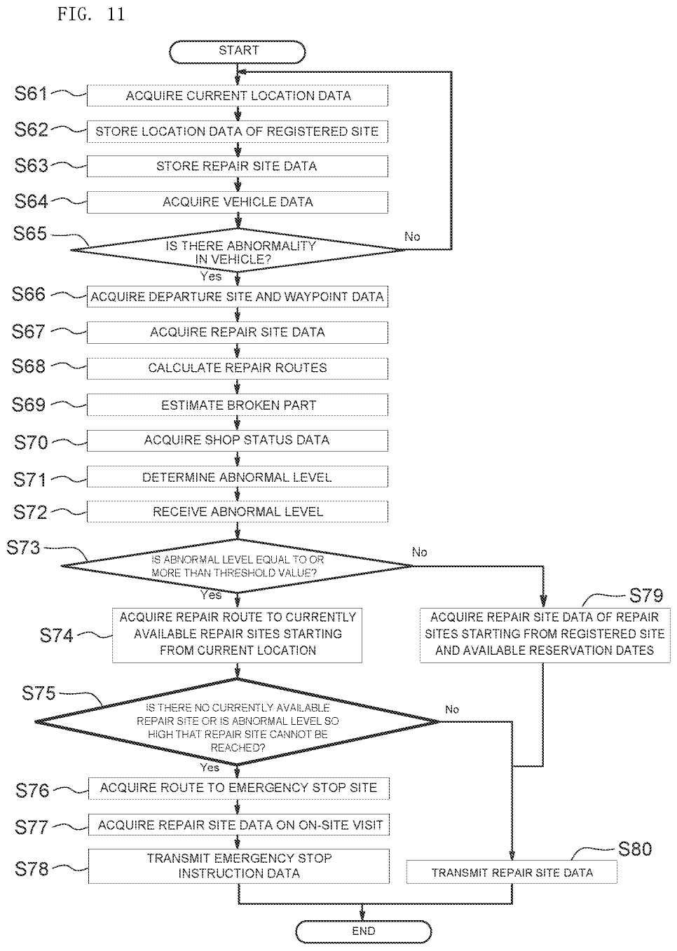

Next, a repair site transmission method performed by the repair site transmission device according to Example 4 will be described with reference to FIG. 11. FIG. 11 is a flowchart illustrating a procedure of the repair site transmission method according to Example 4. In the flowchart of FIG. 11, steps S61 to S73 are the same as in Example 3, thus repeated descriptions will be omitted, and the descriptions already given will be used. Step S74 to step S80 will be described below. In step S74, the server 1 acquires a repair route starting from the current location to a currently available repair site. In step S75, the server 1 determines whether or not there is no currently available repair site in step S74, or whether or not the abnormal level is so high that the vehicle cannot reach the repair site. When making this determination, the server 1 may use abnormal level determination factors such as a remaining distance to travel and a remaining time to travel, or may use other factors. Further, the factor to be used in the determination may be a single factor or include a plurality of factors.

If it is determined in step S75 that there is no currently available repair site or that the abnormal level is so high that the vehicle cannot reach the repair site before the vehicle breaks down, the server 1 proceeds to step S76. If it is not determined that there is no currently available repair site or that the abnormal level is so high that the vehicle cannot reach the repair site, the server 1 proceeds to step S80. In step S76, the server 1 acquires a route to an emergency stop site. In step S77, the server 1 acquires repair site data of a repair site that can visit on site. In step S78, the server 1 transmits, to the vehicle 2 and/or the external terminal 3, emergency stop instruction data including: the route to the emergency stop site acquired in step S76, repair site data of the repair site that can visit on site, and a stop instruction to stop the vehicle 2 at the emergency stop site. In step S79, the server 1 acquires repair site data of repair sites starting from the registered site and their available reservation dates. In step S80, the server 1 transmits the repair site data including the repair route acquired in step S74 or step S79 to the vehicle 2 and/or the external terminal 3. In other words, if the vehicle can reach it by either route, the server 1 transmits the reachable repair route as the repair route to be presented to the user.

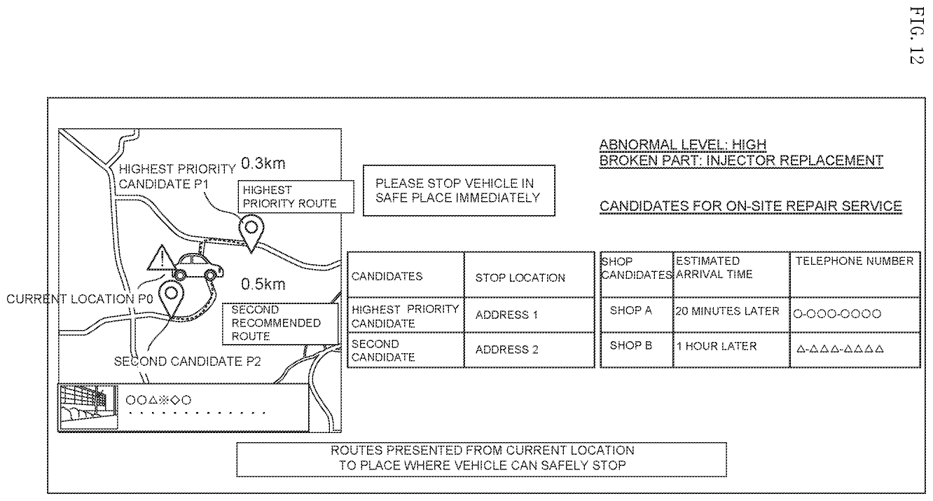

Next, a display example to be displayed on the display of the vehicle 2 and/or the external terminal 3 in Example 4 will be described with reference to FIG. 12. As illustrated in FIG. 12, the locations of candidates for emergency stop site included in the emergency stop instruction data, routes from the current location to the respective emergency stop sites, and the travel distances of the respective routes are displayed. Further, detailed information on on-site repair shops or services that can visit each emergency stop site is displayed. The detailed information includes a phone number and estimated time of arrival at the emergency stop site. Further, an instruction to prompt the user to make an emergency stop is displayed as text data and/or graphic data. Note that the server 1 may acquire shop status data to determine the priorities for presentation of on-site repair shops or services that can visit on site, and display the resulting priorities.

As described above, in the present embodiment, if the abnormal level is equal to or more than a predetermined value and a distance by or a time for which the vehicle can travel from the current location of the vehicle at the time when the abnormality was detected is equal to or less than a threshold value, emergency stop site data of safe emergency stop sites where the vehicle can legally stop is acquired, and a stop instruction to stop the vehicle at the emergency stop site is transmitted to the external device. This allows the user to select a place where the vehicle can safely stop when the vehicle is required to safely stop.

Further, in the present embodiment, if the abnormal level is equal to or more than a predetermined value and a distance by or a time for which the vehicle can travel from the current location of the vehicle at the time when the abnormality was detected is equal to or less than a threshold value, an on-site repair service provider is contacted, and a distance by or a time for which the vehicle can travel is transmitted to the on-site repair service provider. As a result, if the abnormal level is high enough to require the vehicle to safely stop, the on-site repair service provider can be informed of the location where the vehicle is to stop.

Further, in the present embodiment, when an on-site repair service provider is contacted, a meeting site between the user and the on-site repair service provider, which is identified based on the speech in the call between the user of the vehicle and the on-site repair service provider, is stored as the registered site. The meeting site can be stored without the user manually inputting the meeting site. Note that the embodiment described above is described to facilitate understanding of the present invention, and is not described to limit the present invention. Therefore, the elements disclosed in the above embodiment are meant to include all design changes and equivalents that fall within the technical scope of the present invention.

For example, although in the present embodiment, the server 1 in the repair site transmission device 100 of Example 3 includes the broken part estimation unit 41 of Example 2, the repair site transmission device 100 of Example 3 may not include the broken part estimation unit 41, and instead, the repair site transmission device 100 of Example 1 may include the shop status acquisition unit 64. Further, although the server 1 in the repair site transmission device 100 of Example 4 includes the broken part estimation unit 41 of Example 2 and the shop status acquisition unit 64 of Example 3, the repair site transmission device 100 of Example 4 may include one of the broken part estimation unit 41 and the shop status acquisition unit 64 or may not include both. In other words, for Example 4, the repair site transmission device 100 of Example 1 may include the emergency stop determination unit 72, and the repair site transmission device 100 of Example 2 may include the emergency stop determination unit 72.

### DESCRIPTION OF REFERENCE NUMERALS

100 Repair site transmission device
1 Server
10 Location acquisition unit
20 Storage unit
30 Abnormality detection unit
40 Abnormal level determination unit
50 Abnormal level input unit
60 Repair route calculation unit
70 Repair site acquisition unit
80 Transmission unit
2 Vehicle
3 External terminal

1. A repair site transmission device configured to:
store a registered site registered based on information acquired from a vehicle or a user of the vehicle;
receive an input of data indicating an abnormal level associated with a predetermined abnormality of the vehicle;
acquire repair site data of a repair site where a part of the vehicle in which the predetermined abnormality is detected is to be repaired or to be replaced; and
transmit the acquired repair site data to an external device,
wherein an inventory status of a replacement part for the target part or a reservation status of the repair site is acquired; and
the repair site data is acquired according to the abnormal level and the inventory status or the reservation status.

2. The repair site transmission device according to claim 1, further configured to:
acquire a current location of the vehicle; and
determine, based on the abnormal level, whether to acquire the repair site data of the repair site starting from the registered site or to acquire the repair site data of the repair site starting from the current location.

3. The repair site transmission device according to claim 1, wherein the registered site is a site input by the user, a destination, departure site, or waypoint of the vehicle, a site based on a past travel history of the vehicle, or a business site where the vehicle is managed.

4. The repair site transmission device according to claim 3, wherein the site input by the user is a site input into a schedule managed by the user.

5. The repair site transmission device according to claim 2, when the abnormal level is less than a predetermined value, configured to acquire the repair site data of the repair site starting from the registered site.

6. The repair site transmission device according to claim 2, when the abnormal level is equal to or more than a predetermined value, configured to acquire the repair site data of the repair site starting from the current location.

7. The repair site transmission device according to claim 1, wherein the abnormal level is a severity of the abnormality according to an abnormal type of the abnormality.

8. The repair site transmission device according to claim 1, wherein the abnormal level is set based on a travel condition which is a distance by, time for, or range in which the vehicle is allowed to travel with the abnormality not repaired.

9. The repair site transmission device according to claim 2, configured to:
determine, based on the abnormal level, a priority for the repair site in ascending order of distance from the registered site or the current location; and
transmit the repair site data including the priority to the external device.

10. The repair site transmission device according to claim 1, further configured to:
determine the abnormal level;
configured to estimate a target part subject to the abnormality; and
transmit a control instruction to display the target part to the external device.

11. The repair site transmission device according to claim 1, further configured to:
acquire vehicle data of the vehicle from a device or database outside of the vehicle in which the abnormality is detected; and
determine the abnormal level based on the acquired vehicle data.

12. The repair site transmission device according to claim 10, wherein the repair site acquisition unit is configured to:
acquire an inventory status of a replacement part for the target part at the repair site; and
when the abnormal level is less than a predetermined value, acquire, based on the inventory status, the repair site data of the repair site which has the replacement part in stock or requires a shortest number of days to receive the replacement part, among the repair sites starting from the registered site; and
display the registered site to the external device.

13. The repair site transmission device according to claim 1, further configured to:
acquire a current location of the vehicle;
acquire a reservation status of the repair site; and
when the abnormal level is equal to or more than a predetermined value, acquire, based on the reservation status, the repair site data of the repair site which is allowed to be reserved immediately or which is allowed to respond at an earliest possible time among the repair sites within a range of distance by or time for which the vehicle is allowed to travel starting from the current location; and
transmit a display instruction to display the repair site to the external device.

14. The repair site transmission device according to claim 2, configured to:
when the abnormal level is equal to or more than a predetermined value and a distance by or a time for which the vehicle is allowed to travel from the current location of the vehicle at the time when the abnormality was detected is equal to or less than a threshold value, acquire emergency stop site data of a safe emergency stop site where the vehicle is allowed to legally stop; and
transmit a stop instruction to stop at the emergency stop site to the external device.

15. The repair site transmission device according to claim 14, when the abnormal level is equal to or more than a predetermined value and a distance by or a time for which the vehicle is allowed to travel from the current location of the vehicle at the time when the abnormality was detected is equal to or less than a threshold value, configured to contact an on-site repair service provider, and transmit a distance by or a time for which the vehicle is allowed to travel to the on-site repair service provider.

16. The repair site transmission device according to claim 15, when contacting the on-site repair service provider, is configured to store, as the registered site, a meeting site between the user and the on-site repair service provider, identified based on speech in a call between the user of the vehicle and the on-site repair service provider.

17. A repair site transmission method comprising:
storing a registered site registered based on information acquired from a vehicle or a user of the vehicle;
acquiring an inventory status of a replacement part for a target part or a reservation status of a repair site where the target part of the vehicle in which a predetermined abnormality is detected is to be repaired or to be replaced;
receiving an input of data indicating an abnormal level associated with a predetermined abnormality of the vehicle;
acquiring repair site data of the determined repair site according to the abnormal level and the inventory status or the reservation status; and
transmitting the acquired repair site data to an external device.

18. A repair site transmission device configured to:
store a registered site registered based on information acquired from a vehicle or a user of the vehicle;
receive an input of data indicating an abnormal level associated with a predetermined abnormality of the vehicle;
acquire repair site data of a repair site where a part of the vehicle in which the predetermined abnormality is detected is to be repaired or to be replaced;
transmit the acquired repair site data to an external device;
acquire a current location of the vehicle; and
determine, based on the abnormal level, whether to acquire the repair site data of the repair site starting from the registered site or to acquire the repair site data of the repair site starting from the current location.
